(19) United States
(12) Patent Application Publication
(10) Pub. No.: US 2008/0217492 A1
(43) Pub. Date: Sep. 11, 2008

(54) WEARABLE CUSHIONED WRIST SUPPORT FOR COMPUTER USERS

(75) Inventors: JEFFREY STEARNS, HOPATCONG, NJ (US); SAM BRAUNSTEIN, NEW YORK, NY (US)

Correspondence Address: MCKEE, VOORHEES & SEASE, P.L.C., 801 GRAND AVENUE, SUITE 3200, DES MOINES, IA, 50309-2721, US

(73) Assignee: WELLGATE PRODUCTS, LLC, CEDAR RAPIDS, IA (US)

(21) Appl. No.: 12/044,172

(22) Filed: Mar. 7, 2008

Related U.S. Application Data
(60) Provisional application No. 60/905,395, filed on Mar. 7, 2007.

(51) Int. Cl. B43L 15/00

(52) U.S. Cl. 248/118.5

(57) ABSTRACT

A wrist support for supporting a wrist of a user is provided that comprises a plurality of cushioning elements, and a connector for connecting the cushioning elements together, wherein the wrist support is substantially an annulus, and wherein the cushioning elements: comprise a resilient material, are arranged adjacent to one another in the annulus, are arranged radially about the central axis of the annulus, and are capable of being disposed on the user's wrist in a position wherein the user experiences minimal or no wrist strain. The wrist support supports the wrist comfortably in a neutral position that minimizes or eliminates wrist strain when the user is engaged in an activity that involves repetitive wrist or hand movements such as computer mouse usage or typing.

### CROSS-REFERENCE TO RELATED APPLICATIONS

This application claims the benefit of co-pending U.S. patent application Ser. No. 29/291,741, filed Sep. 12, 2007 and priority under 35 U.S.C. § 119 to and the benefit of co-pending U.S. provisional patent application Ser. No. 60/905,395, filed Mar. 7, 2007, both of which are incorporated herein by reference in their entireties.

### FIELD OF THE INVENTION

The present invention relates to wrist supportive devices. More particularly, the invention relates to wearable cushioned wrist supports for individuals who routinely engage in activities that involve repetitive movements of the wrist and hands such as directing a computer mouse and typing on a computer keyboard.

### BACKGROUND OF THE INVENTION

Computer users are susceptible to Repetitive Strain Injuries (also known as Repetitive Stress Injuries or RSI) such as Carpal Tunnel syndrome, tenosynovitis and tendonitis of the wrist. It is well known in the art that RSI can be ameliorated or prevented through the use of a cushioned wrist support to hold the wrist in a neutral position that minimizes or eliminates wrist strain while typing or when using a computer mouse. However, typical ergonomic wrist cushions only function properly when located in the correct position on the desktop. Since using a mouse is a dynamic function, the wrist cushion is often out of position and therefore cannot function properly. Even if the wrist cushion is fixed to a mouse pad to stay in place, the fact that the cushion is static and the wrist is moving creates friction and resistance to the motion(s) that the user must employ to use the mouse.

There is therefore a need in the art for a cushioned wrist support that moves with the user's wrist and always stays in proper position. There is further a need in the art for a cushioned wrist support that enhances, not inhibits movement. Since wrist cushions currently available in the art are bulky and even heavy, a minimal, lightweight design is needed for ease of user wrist movement. Further, there is a need in the art for a wrist support device that is aesthetically pleasing to the user. Such aesthetic appeal is important for compliance by users, since users such as office workers may not want to appear to their co-workers to have a wrist injury. Moreover, there is a need in the art for an aesthetically pleasing wrist support device that is easy to use, comfortable and that fits either hand (or both) during various wrist movements performed by the user, such as typing or using a computer mouse. There is also a need in the art for a wrist support device that is inexpensive and has a one size fits all design so that it can be supplied in quantities to large groups of users, such as a group of workers in an office. There is further a need in the art for a wrist support that does not impede other normal hand/wrist functions.

Citation or identification of any reference in Section 2, or in any other section of this application, shall not be considered an admission that such reference is available as prior art to the present invention.

### SUMMARY OF THE INVENTION

A wearable cushioned wrist support for supporting a wrist of a user is provided. In one embodiment, the wrist support can comprise:

a. a plurality of cushioning elements, and
b. a connector for connecting the cushioning elements together,
wherein the wrist support is substantially an annulus, and
wherein the cushioning elements:
comprise a resilient material,
are arranged adjacent to one another in the annulus,
are arranged radially about the central axis of the annulus, and
are capable of being disposed on the user's wrist in a position wherein the user experiences minimal or no wrist strain.

In another embodiment, the annulus is selected from the group consisting of circle, loop, ring, doughnut, and oval.

In another embodiment, the wrist support is substantially symmetrical.

In another embodiment, each cushioning element is substantially symmetrical.

In another embodiment, each cushioning element is substantially spherical or cylindrical.

In another embodiment, the connector is selected from the group consisting of a cord, a wire, a string, an elastic cord, a rope, a thread, a ball and socket connector, and a screw connector.

In another embodiment, the connector is integral to one or more of the cushioning elements.

In another embodiment, at least two cushioning elements are capable of being grasped and twisted around the connector and around one another, thereby enabling the user to decrease the circumference of the wrist support.

In another embodiment, an annular wrist support for supporting a wrist of a user is provided that comprises:

a. an annular outer surface;
b. an annular inner surface;
c. two annular lateral edges disposed between the annular outer surface and the annular
inner surface and integral therewith;
wherein the annular wrist support:
is substantially annulate, circinate, loop-shaped, ring-shaped, doughnut-shaped, oval-shaped, or round,
is substantially symmetrical,
comprises a resilient material,
is capable of being expanded to allow mounting of the wrist support on the user's wrist, and remains continuous or joined during mounting on the user's wrist.

In another embodiment, the resilient material has portions defining a hollow.

In another embodiment, a wrist support for supporting a wrist of a user is provided that comprises:

a. a plurality of substantially spherical cushioning elements, and
b. an expandable connector for connecting the cushioning elements together,
wherein the wrist support:
is substantially annulate, circinate, loop-shaped, ring-shaped, doughnut-shaped, oval-shaped, or round,
is substantially symmetrical, and
comprises a resilient material, and wherein
the expandable connector is a continuous loop that is capable of being expanded to allow mounting of the wrist support on the user's wrist,
the continuous loop remains continuous during mounting,
each cushioning element of the plurality of cushioning elements has portions defining a hole through the cushioning element,
the expandable connector is conducted through the hole,
each cushioning element is disposed adjacent to another cushioning element, wherein the ring is substantially symmetrical, and
the substantially spherical cushioning elements are arranged radially about the central axis of the ring.

In another embodiment, the connector comprises a first end and a second end opposite the first end, and wherein the first end and the second end are joined, thereby forming the continuous loop.

In another embodiment, a wrist support for supporting a wrist of a user is provided that comprises:

a. a plurality of substantially spherical cushioning elements, and
b. an expandable connector for connecting the cushioning elements together, wherein:
the wrist support is substantially annulate, circinate, loop-shaped, ring-shaped, doughnut-shaped, oval-shaped, or round,
the wrist support is substantially symmetrical,
the expandable connector is an elastic cord,
the elastic cord is a continuous loop capable of being expanded to allow mounting of the wrist support on the user's wrist,
the continuous loop remains continuous during mounting,
each cushioning element has portions defining a hole through the cushioning element,
the expandable connector is conducted through the hole,
the substantially spherical cushioning elements are arranged adjacent to one another in a ring,
the substantially spherical cushioning elements are arranged radially about the central axis of the ring, and
the cushioning elements are capable of rotating around the expandable connector.

In another embodiment, a method for supporting a wrist of a user engaged in an activity that involves repetitive wrist or hand movements is provided. The method can comprise:

a. providing the user with the wrist support of claim 1; and
b. wearing the wrist support on the wrist during the repetitive wrist or hand movements.

In another embodiment, a method for ameliorating or preventing Repetitive Strain Injury (RSI) in a wrist of a user engaged in an activity that involves repetitive wrist or hand movements is provided. The method can comprise:

a. providing the user with the wrist support of claim 1; and
b. wearing the wrist support on the wrist during the repetitive wrist or hand movements, wherein the wearing of the wrist support aligns the wrist in an alignment that is beneficial for wrist health or safety.

### BRIEF DESCRIPTION OF THE DRAWINGS

The present invention is described herein with reference to the accompanying drawings, in which similar reference characters denote similar elements throughout the several views. It is to be understood that in some instances, various aspects of the invention may be shown exaggerated or enlarged to facilitate an understanding of the invention.

FIG. 1 is a side view of one embodiment of the wearable cushioned wrist support of the invention.

FIG. 2 is a plan view of one embodiment of the wearable cushioned wrist support of the invention.

FIG. 3 is a perspective view of one embodiment of the wearable cushioned wrist support of the invention.

FIG. 4 is a side view of one embodiment of the wearable cushioned wrist support that has a textured surface design.

FIG. 5 is a plan view of one embodiment of the wearable cushioned wrist support that has a textured surface design.

FIG. 6 is a perspective view of one embodiment of the wearable cushioned wrist support that has a textured surface design.

FIG. 7 is a side view of one embodiment of the wearable cushioned wrist support that has a colored (or patterned) surface design.

FIG. 8 is a plan view of one embodiment of the wearable cushioned wrist support that has a colored (or patterned) surface design.

FIG. 9 is a perspective view of one embodiment of the wearable cushioned wrist support that has a colored (or patterned) surface design.

FIG. 10 is a schematic diagram of one embodiment of the wearable cushioned wrist support with spherical cushioned elements. In this specific embodiment, each sphere, 1002, has a diameter of 23±5 mm. The inner (wrist-side) circumference of the wrist support, 1004, is 148±20 mm. The circumference of the connector (e.g., an elastic cord), 1006, running through the centerline of the spheres is 1.51±1 mm. The resilient spheres are capable of compressing slightly at their points of contact with one another, 1008.

FIG. 11A is a diagram showing a typical position for a user's wrist during the use of a computer mouse. FIG. 11B is a diagram showing one embodiment of the wearable cushioned wrist support supporting the wrist in a neutral position that minimizes or eliminates wrist strain during use of a computer mouse. Dotted line arrows indicate the plane of wrist alignment.

FIG. 12 is a diagram showing how one embodiment of the wearable cushioned wrist support can be adjusted to a smaller wrist circumference by grasping two cushioning elements (spheres are depicted here) at once and twisting them around the connector and around one another, thereby enabling the user to decrease the circumference of the wrist support.

FIG. 13 shows a schematic diagram of one embodiment of the wrist support wherein the sphere comprises with a liquid gel center covered with a 10-20ShoreA skin. A. Plan view. B. Side view.

FIG. 14 shows a schematic diagram of one embodiment of the wrist support wherein the sphere is hollow with a 2-3 mm thick 10-20ShoreA skin. A. Plan view. B. Side view.

FIG. 15 shows a schematic diagram of one embodiment of the wrist support of the invention wherein the sphere has a small cavity at the center to make the sphere soft and compressible. A. Plan view. B. Side view.

FIG. 16 shows a diagram of one embodiment of the wrist support that is supporting the wrist in a dynamic fashion.

FIGS. 17-19 show diagrams of one embodiment of the wrist support in which the spheres or cylinders are of graduated or varying sizes. FIG. 17, side view. FIG. 18, plan view. FIG. 19; perspective view.

FIG. 20. Plan view. This specific embodiment of the wrist support (also shown in FIGS. 17-19) has an outer diameter (unstretched) of approximately 84 mm and an inner diameter of 44 mm. The spheres are of graduated sizes with diameters as indicated: 15.9 mm, 17.5 mm, 19.1 mm, 20.6 mm, 22.2 mm and 23.8 mm.

FIGS. 21-24 show diagrams of an embodiment of the wrist support in which the elements are non-spherical and have cylindrical shapes with an internal (wrist-side) dimension of the cylinder that is smaller than the external (outside) dimension. FIG. 21, side view. FIG. 22, plan view. FIG. 23, perspective view.

FIG. 24. Plan view. This specific embodiment of the wrist support (also shown in FIGS. 21-23) has an inner diameter of 44 mm. Each of the 10 cushioning elements depicted in this embodiment comprises approximately 36° of the annulus.

FIGS. 25-28 show diagrams of an embodiment of the wrist support in which one element is non-spherical and has modified “dogbone” shape. FIG. 25, side view. FIG. 26, plan view. FIG. 27; perspective view. FIG. 24.

FIG. 28. Plan view. This specific embodiment of the wrist support (also shown in FIGS. 25-27) has an outer diameter of approximately 86 mm (unstretched). Each spherical cushioning elements depicted in this embodiment is approximately 20 mm in diameter. The “dogbone” is approximately 20 mm in diameter at the rounded, partially spherical ends, and about 63 mm long.

FIGS. 29-31 show diagrams of a one-piece embodiment of the wrist support. FIG. 92, side view. FIG. 20, plan view. FIG. 31; perspective view.

FIG. 32 shows a diagram of a one-piece embodiment of the wrist support.

FIG. 33. Plan view. This specific embodiment of the wrist support (also shown in FIGS. 29-31 and 34) has an outer diameter of approximately 61 mm (unstretched) and an inner diameter of 49 mm (unstretched).

FIG. 34. Side view. This specific embodiment of the wrist support (also shown in FIGS. 29-31 and 33) is approximately 16 mm wide.

### DETAILED DESCRIPTION OF THE INVENTION

A wearable cushioned wrist support is provided for use by computer users, typists and other users susceptible, at risk, or suffering from repetitive strain injury (RSI).

The wearable cushioned wrist support moves with the user's wrist and stays in proper position on the wrist during typing and computer mouse use, and does not impede other normal hand/wrist functions. The wearable cushioned wrist support does not inhibit movement and has minimal, lightweight design. The wearable cushioned wrist support is aesthetically pleasing to the user and is easy to use, comfortable and that fits either hand (or both) during various wrist movements performed by the user, such as typing or using a computer mouse. The wearable cushioned wrist support can be produced and sold inexpensively and has a one size fits all design.

In one embodiment, the wrist support can comprise: a plurality of cushioning elements, and a connector for connecting the cushioning elements together, wherein the wrist support is substantially an annulus, loop or ring, and wherein the cushioning elements: comprise a resilient material, are arranged adjacent to one another in the annulus, are arranged radially about the central axis of the annulus (or loop or ring), and are capable of being disposed on the user's wrist in a position wherein the user experiences minimal or no wrist strain.

In one embodiment, the shape of the annulus (or loop or ring) is selected from the group consisting of annular, circular or circinate, loop-shaped, ring-shaped, doughnut-shaped, oval-shaped, and round.

In another embodiment, each cushioning element can be substantially symmetrical. In another embodiment, each cushioning element can be substantially spherical or cylindrical.

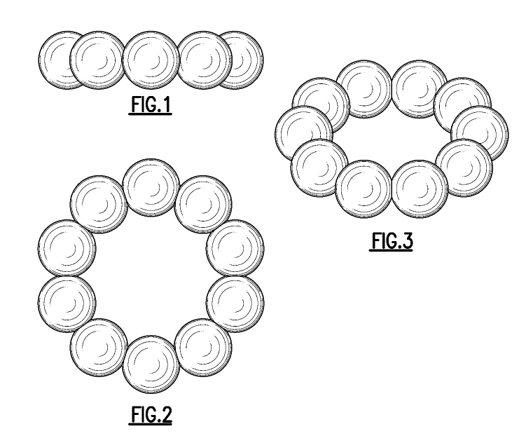

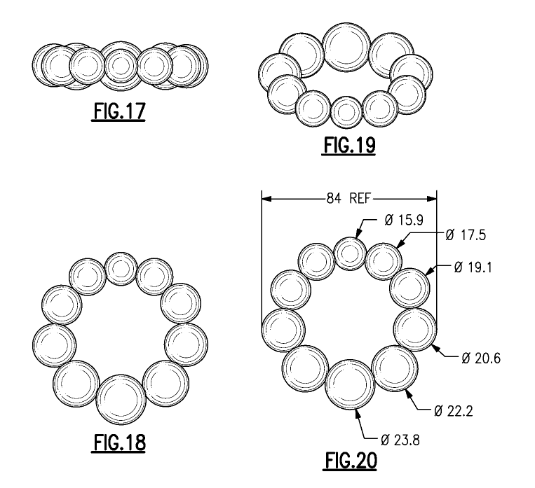

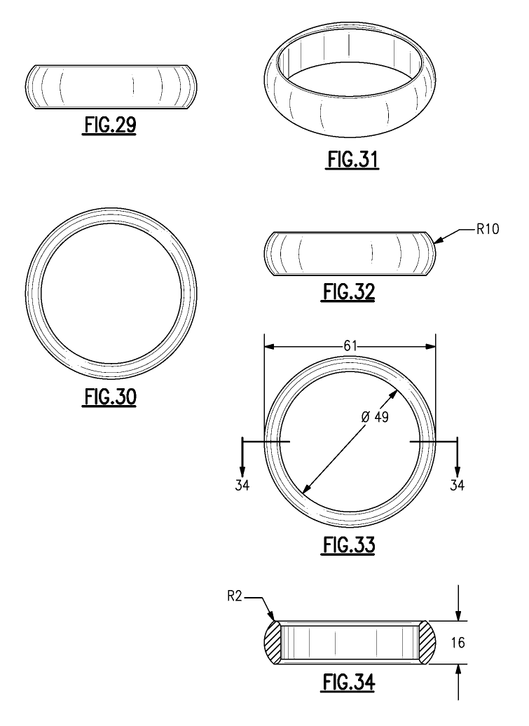

In one embodiment, the wrist support can be substantially symmetrical along its x-, y- and z-axes (FIGS. 1-8, 21-24, 29-32).

In another embodiment, the top and bottom views of the wrist support (plan views, see FIGS. 2, 5, 8, 18, 22, 26 and 30) can be substantially identical, e.g., the top and bottom surfaces are nearly or completely indistinguishable.

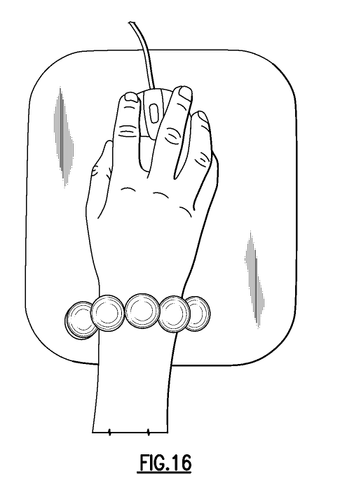

In another embodiment, the loop or ring can comprise a plurality of cushioning elements that are substantially spherical or cylindrical (hereinafter “spheres” or “cylinders”), arranged radially about a center point and connected together or arranged adjacent to one another by one or more connectors (FIGS. 1-10, 17-24).

In still another embodiment, the loop or ring can comprise a plurality of cushioning elements that are substantially button-shaped, whereby numerous cylindrical shaped cushioning elements may be arranged radially about a center point and connected together or arranged adjacent to one another by one or more connectors (not shown). Due to the additional surface area provided by the additional elements, this embodiment should provide additional cushion and flexibility to the user.

FIG. 10 is a schematic diagram of one embodiment of the wearable cushioned wrist support with spherical cushioned elements. In this specific embodiment, each sphere, 1002, has a diameter of 23±5 mm. The inner (wrist-side) circumference of the wrist support, 1004, is 148±20 mm. The circumference of the connector (e.g., an elastic cord), 1006, running through the centerline of the spheres is 1.51±1 mm.

The cushioning elements can be soft and/or resilient. They can be capable of compressing slightly at their points of contact with one another (FIG. 10, 1008).

The modular arrangement of the cushioning elements provides many health benefits and other advantages, such as flexibility in manufacturing at a relatively low cost. The modularity also keeps the design of the wrist support simple, easy to use, one-size-fits-all, lightweight and aesthetically pleasing.

In a specific embodiment, the wrist support comprises:

a plurality of substantially spherical cushioning elements, and

an expandable connector for connecting the cushioning elements together,
wherein:
the wrist support is substantially annulate, circinate, loop-shaped, ring-shaped, doughnut-shaped, oval-shaped, or round,
the wrist support is substantially symmetrical,
the expandable connector is an elastic cord,
the elastic cord is a continuous loop capable of being expanded to allow mounting of the wrist support on the user's wrist,
the continuous loop remains continuous during mounting,
each cushioning element has portions defining a hole through the cushioning element,
the expandable connector is conducted through the hole,
the substantially spherical cushioning elements are arranged adjacent to one another in a ring,
the substantially spherical cushioning elements are arranged radially about the central axis of the ring, and
the cushioning elements are capable of rotating around the expandable connector.

In another embodiment, the wearable cushioned wrist support comprises an annular or one-piece cushioning element comprising a soft resilient flexible material (FIGS. 29-34).

In one embodiment, the annular wrist support can comprise:

a. an annular outer surface;

b. an annular inner surface;

c. two annular lateral edges disposed between the annular outer surface and the annular inner surface and integral therewith;

wherein the annular wrist support:

is substantially annulate, circinate, loop-shaped, ring-shaped, doughnut-shaped, oval-shaped, or round,

is substantially symmetrical,

comprises a resilient material,

is capable of being expanded to allow mounting of the wrist support on the user's wrist, and

remains continuous or joined during mounting on the user's wrist.

In another embodiment, the resilient material has portions defining a hollow.

The annular wrist support can additionally comprise a first end, a second end opposite the first end, and a securing portion.

Any suitable connecting material or connector known in the art can be used as a connector to connect or arrange the elements (e.g., spheres or cylinders) into a loop, e.g., a cord, wire, string, rope, thread, nylon filament, ball and socket connectors, etc. In one embodiment, the material can be conducted, e.g., strung or threaded, through holes (or channels) in the spheres or cylinders to connect them.

In one embodiment, the cushioning element has portions defining a hole through the cushioning element. The portions defining the hole can be arranged along a central axis of the cushioning element and the connector can be conducted through the hole. Optionally, the cushioning elements can be capable of rolling or of rotating around the connector.

In another embodiment, the connector can be integral to one or more of the cushioning elements. For example, the connector can be an extruded portion of resilient material that links one cushioning element to another cushioning element adjacent to it. The connector can also be attached to, inserted into, or molded into the cushioning element. In a specific embodiment, the connector is an integral part of the cushioning element and molded out of a thin or string-like portion of the same material as the cushioning element.

In another embodiment, the connector can surround the cushioning elements. For example, the connector can be a thin, elastic, stretchable or expandable fabric or material such as spandex that surrounds the plurality of cushioning elements, e.g., a fabric tube, and can hold the plurality of cushioning elements together to form a ring, loop, oval or other annulus-shaped structure. In such an embodiment, a second connector can be optionally conducted through holes (or channels) in the cushioning elements.

In another embodiment, the connector can comprise a first end and a second end opposite the first end. The first end and the second end can be joined, thereby forming a continuous loop.

In another embodiment, the connector can comprise at least two ends.

In another embodiment, the wrist support additionally comprises a securing portion. The two (or more) ends can be joined by a securing portion, such as a strap, clasp or buckle. The securing portion can be, for example, any clasp known in the art that can be unclasped so that the two ends are separated. The clasp can be a “jewelry-style” or decorative clasp or buckle, or of a more utilitarian design, e.g., a quick-release buckle.

In another embodiment, the wrist support can be mounted on the user's wrist by sliding the wrist support over the user's hand without opening or closing the securing portion.

In another embodiment, spheres or cylinders can be strung adjacent to one another on an elastic cord, which is connected end-to-end to form a loop or ring. Such a radial array of soft spheres or cylinders can comfortably fit a broad size range and is easy for the user to put on and take off of the wrist.

In another embodiment, each sphere is of a diameter and degree softness to provide appropriate positioning and comfort while using any standard computer mouse. Such diameters and degrees of softness can be determined by routine methods known in the art.

In a preferred embodiment, the diameter of the spheres or cylinders ranges from 18 mm to 28 mm.

In another embodiment, of the cushioning elements can be of equal diameter or size, or of substantially the same diameter or size.

In another embodiment, the cushioning elements can be of graduated or varying sizes (FIGS. 17-20).

In another embodiment, the cushioning elements are cylinders.

In another embodiment, the spheres or cylinders have a durometer range of 10ShoreA to 10Shore00. Such a durometer range will provide spheres or cylinders that support the wrist comfortably in a neutral position that minimizes or eliminates wrist strain during use of a computer mouse. Such a neutral wrist position is well known in the art, and can be determined using standard methods and information known in the art, see, e.g., on-line articles posted on the World Wide web entitled “Carpal Tunnel Syndrome” by the American Academy of Orthopedic Surgeons at orthoinfo.aaos.org/brochure/printer_page.cfm?topcategory=Hand&Thread_ID=5, available on-line on Sep. 30, 2007; and entitled “Carpal Tunnel Syndrome” by the National Women's Health Information Center, U.S. Department of Health and Human Services, Office on Women's Health, at www.4women.gov/faq/carpaltun.pdf available on-line on Sep. 30, 2007).

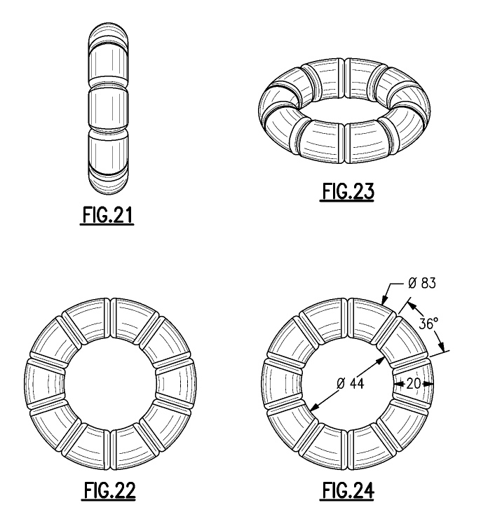

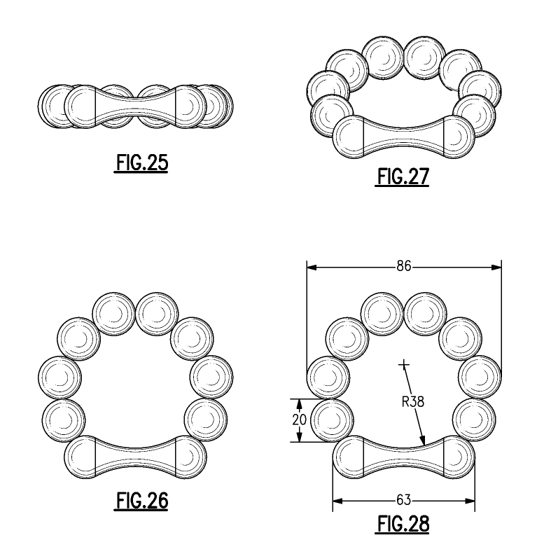

In a specific embodiment, the wrist support can have one or more elements that are non-spherical. The specific embodiment shown in FIGS. 25-28, one of the cushioning elements has modified “dogbone” shape. According to this embodiment, when the wrist support is positioned on the wrist, the dogbone element can be in contact with the ventral surface of the wrist (FIGS. 25-28). In the specific embodiment of the wrist support shown in FIG. 28, the wrist support has an outer diameter of approximately 86 mm (unstretched). Each spherical cushioning elements depicted in this embodiment is approximately 20 mm in diameter. The “dogbone” is approximately 20 mm in diameter at the rounded, partially spherical ends, and about 63 mm long.

In another embodiment, the spheres or cylinders (or cylinders or one-piece bracelet-style element) are made of a material that comprises a resilient material, such as a resilient elastomer. Such resilient elastomeric materials are well known in the art, and include, but are not limited to, TPE (thermoplastic polymer elastomer) including polyamide series elastomer, polyurethane series elastomer, polyester series elastomer, polyolefin series elastomer, styrene block series elastomer and the like. The resilient material can also comprise silicone and/or rubbers including synthetic and natural rubber. TPE is the preferred resilient material for use in the invention.

Other resilient materials known in the art can also be used to form the spheres or cylinders.

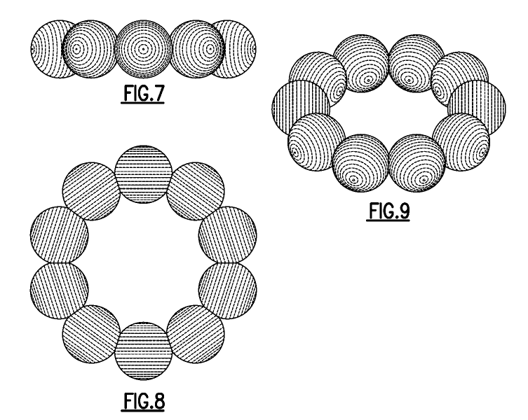

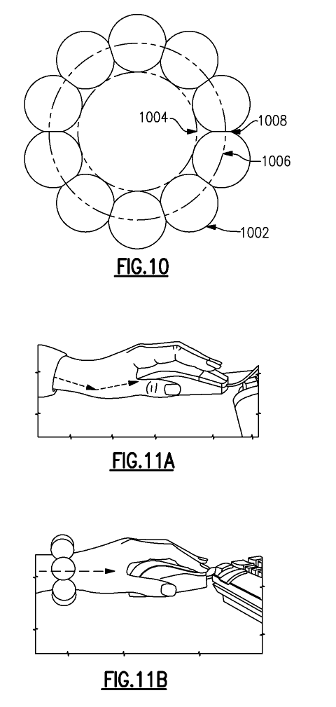

In another embodiment, the resilient material (e.g., elastomer) is colored, multi-colored, patterned, pearlescent, iridescent, fluorescent, translucent or crystal clear (FIGS. 7-9).

In another embodiment, the surface of the cushioning element is textured or flocked.

The cushioning elements, e.g., spheres or cylinders, can be made according to methods well known in the art, e.g., injection molding, liquid injection molding, compression molding, transfer molding, and rotational molding.

In another embodiment, the inside circumference of the ring of cushioning elements, e.g., spheres or cylinders, ranges from 128 mm to 168 mm when the connecting material is in a relaxed position.

In another embodiment, the inside circumference of the one-piece bracelet-style element ranges from 128 mm to 168 mm.

In another embodiment, the connector, e.g., an elastic cord, runs through the center line of each sphere (or cylinder) forming a modular assembly of spheres or cylinders (or cylinders) to fit the wrist. In a specific embodiment, the plurality of cushioning elements, e.g., spheres or cylinders, is 10±1 spheres or cylinders

In a preferred embodiment, the connector, e.g., an elastic cord, can have a diameter of 0.5 mm to 2 mm and can recover to within 10% of its relaxed length after being stretched to 200%. An assembly of spheres or cylinders connected by such a cord can easily stretches over the hand and can fit a wrist circumference range of 120 mm (5% female) to 215 mm (95% male).

In another embodiment, at least two cushioning elements of the wrist support are capable of being grasped and twisted around the connector and around one another, thereby enabling the user to decrease the circumference of the wrist support. By grasping two spheres or cylinders at once and twisting, the wrist support can be adjusted to an even smaller circumference (FIG. 12), in order to adjust the fit to a user's smaller wrist circumference.

In one embodiment, the wrist support is used to comfortably support the wrist in a neutral position while enhancing controlled hand movement during use of a computer mouse (FIGS. 1A-B, 16).

Since in one embodiment, the spheres or cylinders are made of a resilient elastomer, the soft spheres or cylinders are somewhat compressible under the weight of the wrist. Therefore, the spheres or cylinders on the back of the wrist remain aesthetically spherical while the spheres or cylinders under the wrist are compressed to approximately 50% of their relaxed diameter. According to the invention, this compressed dimension of the spheres or cylinders is designed to support the wrist in a neutral position, which is well known in the art to prevent RSI.

The wrist support can be worn on either the right or left wrists, or on both for activities that involve both wrists, such as typing. For example, a wrist support can be worn on each wrist, so that the wrists are held in a neutral position while typing on a computer keyboard.

Under certain circumstances, e.g., for additional comfort when the user's wrist is particularly sensitive, a plurality of wrist supports (e.g., two supports) can be worn on the same wrist.

During normal use, a computer mouse is moved in the X and Y dimensions on the plane formed by the desktop or flat support surface on which it moves. A user's wrist can swivel to the left and right for X-dimension movement. In this dimension, the spheres or cylinders in the wrist support are in full alignment on the wrist and therefore provide controlled range of motion and support. To move the mouse in the Y dimension, the whole arm may need to move back and forth. In this case, the spheres or cylinders on the wrist roll on the axis of the elastic cord, providing appropriate wrist support in a dynamic fashion (FIG. 16).

In another embodiment, the surface of each sphere is made to have a low coefficient of friction. Therefore, in the X-dimension, the device can slide freely for controlled range of motion.

Since each ball can feature color, multi-colors, pearlescence, iridescence, fluorescence, translucence or be crystal clear, have a pattern, texture or flocking on its surface, the wrist support can be worn as a fashion accessory.

As the resilient spheres or cylinders compress under the weight of the wrist, their surface area against the wrist expands, thus increasing the comfort of the user. The uncompressed spheres or cylinders not under the weight of the wrist make minimal skin contact (tangency), which maximizes breathability and comfort.

Because of the modular design, small gaps may occur between spheres or cylinders that are strung together, e.g., on cord. Locating these small gaps at tender or sensitive landmarks of affected wrist areas or protuberances increases comfort during use.

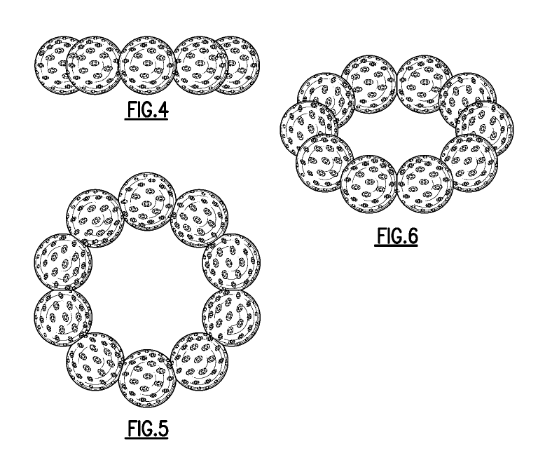

The entire assembly can be covered, for example, with a thin, elastic or stretchable fabric connector (e.g., spandex), which can be used as a connector instead of a connector conducted through the elements (e.g., an elastic cord). A spandex covering connector can also enhance wrist sliding or gliding across a desktop during use. Another way of reducing surface friction, as well as to provide an ornamental finish to the outside of an element, is to provide a texture or flocking to the outside surface of each element (FIGS. 4-6).

As a novelty, a translucent sphere can have, for example, objects imbedded inside including molded parts or even LED lights.

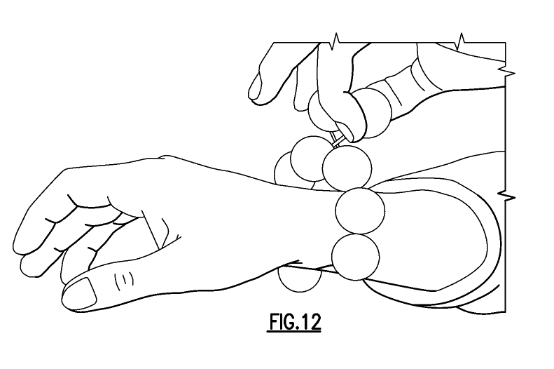

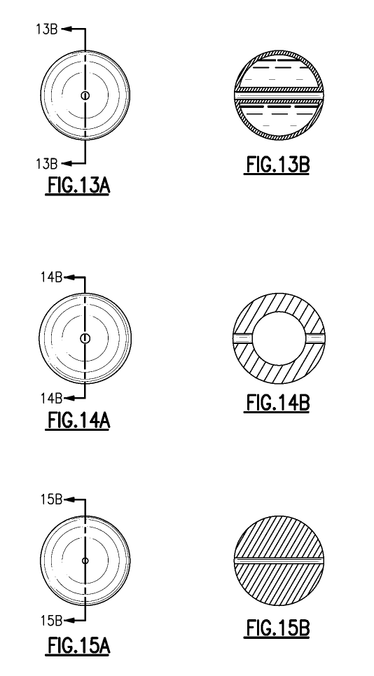

In a preferred embodiment, spheres or cylinders are made of a solid, soft elastomer such as silicone, TPR, or polyurethane. Alternatively, the wrist support works equally well if each sphere achieves soft resiliency by being made of foam rubber (2-3 lb density), or made with a liquid gel center covered with a 10-20ShoreA skin (FIG. 13), or made hollow with a 2-3 mm thick 10-20ShoreA skin (FIG. 14). The preferred solid elastomer sphere achieves its softness through the durometer of its formulation. In addition, that softness can also be controlled by adding a small cavity at the center (FIG. 15) of each sphere. In this case, the larger the cavity is, the softer the cushion.

In one embodiment, a wrist support is provided that forms a continuous annulus, ring, oval or loop. In another embodiment, the wrist support can have a first end and a second end opposite the first end that are joined to form a continuous annulus, ring, oval or loop.

In another embodiment, the wrist support can have no securing portion, for example, a clasp, strap, buckle, or other fastener. It can be a simple annulus, ring, oval or loop devoid of accessories such as pockets, pads, clasps, straps, buckles or fasteners.

In another embodiment, a wrist support is provided wherein the wrist support can be mounted on the user's wrist by sliding the wrist support over the user's hand without opening or closing a securing portion, for example, a clasp, strap, buckle, or other fastener.

In another embodiment, a substantially circular, oval, ring-like and/or symmetrical wrist support is provided that comprises substantially symmetrical cushioning spheres. The spheres can be connected by stringing the spheres through the center with an elastic element. The wrist support can be donned by sliding the elastic assembly over the user's hand without opening or closing any securing portion.

In another embodiment, a substantially circular, oval, ring-like and/or symmetrical wrist support is provided that comprises substantially symmetrical cushioning spheres. The spheres can be connected by stringing the spheres through the center with an elastic element. The cushioning spheres can rotate around the axis defined by the elastic element. The wrist support can be donned by sliding the elastic assembly over the user's hand without opening or closing any securing portion.

In another embodiment, a wrist support is provided that is one-piece and comprises a rounded tube (hollow or solid) fashioned from an elastic or resilient material (FIGS. 29-34). The wrist support can be donned by sliding it over the user's hand without opening or closing any securing portion. The specific embodiment of the wrist support shown in FIG. 33 has an outer diameter of approximately 61 mm (unstretched) and an inner diameter of 49 mm (unstretched) and is approximately 16 mm wide (FIG. 34).

In another embodiment, a substantially circular, oval, ring-like and/or symmetrical wrist support is provided that that comprises substantially symmetrical cushioning spheres. The spheres can be connected by stringing the spheres through the center with an elastic element.

In another embodiment, the wrist support has no top or bottom frame, no covering, no operable closure, clasp or fastener mechanism, no differentiated bottom or top elements, or no differentiated inside and outside materials. In a specific embodiment, the cushioning elements are constructed from a single type of elastic or resilient material. In another embodiment, the wrist support has no enlarged buttress or padding portion. Such embodiments of the wrist support can enable the user to don the wrist support by sliding the elastic assembly over the user's hand without opening or closing any strap, buckle, or other fastener. In certain embodiments, the cushioned wrist support of the invention can weigh considerably less than currently available wrist supports. For example, in one embodiment, the wrist support weighs 29 g-51 g. A traditional desktop wrist gel cushion for mouse weighs approximately 91 g and a traditional desktop wrist gel cushion for typing weighs approximately 417 g.

Use of the cushioned wrist support can provide additional health benefits to the user, including but not limited to stress relief and wrist massage. Because of the wrist support's modular design, the diameter of the cushioning elements, e.g., spheres or cylinders, the shape of each element, the number of elements and the length of the connector (e.g., elastic cord or spandex wrapper) can be modified to make other support devices that fit other body parts (e.g., palmar surface, heel of palm, ankle, knee, neck, etc.) and provide other supportive functionalities.

The wearable cushioned wrist support can support the wrist in a position that can minimize or eliminate wrist strain during use of a computer mouse, keyboard typing and other activities that aggravate the wrist and cause or exacerbate wrist pain, repetitive stress injury (RSI), carpal tunnel syndrome and other wrist injuries or wrist pain syndromes. Such a neutral wrist position is well known in the art, and can be determined using standard methods and information known in the art, see, e.g., on-line articles posted on the World Wide Web entitled “Carpal Tunnel Syndrome” by the American Academy of Orthopedic Surgeons at orthoinfo.aaos.org/brochure/printer_page.cfm?topcategory=Hand&Thread_ID=5, available on-line on Sep. 30, 2007; and entitled “Carpal Tunnel Syndrome” by the National Women's Health Information Center, U.S. Department of Health and Human Services, Office on Women's Health, at www.4women.gov/faq/carpaltun.pdf available on-line on Sep. 30, 2007).

A method for supporting a wrist of a user engaged in an activity that involves repetitive wrist or hand movements is provided. The method can comprise:

a. providing the user with a wrist support of the invention; and

b. wearing the wrist support on the wrist during the repetitive wrist or hand movements.

A method for ameliorating or preventing wrist injury, e.g., Repetitive Strain Injury (RSI) or carpal tunnel syndrome, in a wrist of a user engaged in an activity that involves repetitive wrist or hand movements is also provided. The method can comprise

a. providing the user with a wrist support of the invention; and

b. wearing the wrist support on the wrist during the repetitive wrist or hand movements. Wearing the wrist support can align the wrist in an alignment that is beneficial for wrist health or safety, e.g., in a neutral wrist position.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

What is claimed is:

1. A wrist support for supporting a wrist of a user comprising:
a. a plurality of cushioning elements, and
b. a connector for connecting the cushioning elements together,
wherein the wrist support is substantially an annulus, and
wherein the cushioning elements:
comprise a resilient material,
are arranged adjacent to one another in the annulus,
are arranged radially about the central axis of the annulus, and
are capable of being disposed on the user's wrist in a position wherein the user experiences minimal or no wrist strain.

2. The wrist support of claim 1 wherein the annulus is selected from the group consisting of circle, loop, ring, doughnut, and oval.

3. The wrist support of claim 1 that is substantially symmetrical.

4. The wrist support of claim 1 wherein each cushioning element is substantially symmetrical.

5. The wrist support of claim 1 wherein each cushioning element is substantially spherical or cylindrical.

6. The wrist support of claim 1 wherein the connector is selected from the group consisting of a cord, a wire, a string, an elastic cord, a rope, a thread, a ball and socket connector, and a screw connector.

7. The wrist support of claim 1 wherein the connector is integral to one or more of the cushioning elements.

8. The wrist support of claim 1 wherein at least one cushioning element is capable of being grasped and twisted around the connector, thereby enabling the user to decrease the circumference of the wrist support.

9. An annular wrist support for supporting a wrist of a user comprising:
a. an annular outer surface;
b. an annular inner surface;
c. two annular lateral edges disposed between the annular outer surface and the annular inner surface and integral therewith;
wherein the annular wrist support:
is substantially annulate, circinate, loop-shaped, ring-shaped, doughnut-shaped, oval-shaped, or round,
is substantially symmetrical,
comprises a resilient material,
is capable of being expanded to allow mounting of the wrist support on the user's wrist, and remains continuous or joined during mounting on the user's wrist.

10. The annular wrist support of claim 9 wherein the resilient material has portions defining a hollow.

11. A wrist support for supporting a wrist of a user comprising:
a. a plurality of substantially spherical cushioning elements, and
b. an expandable connector for connecting the cushioning elements together, wherein the wrist support:
is substantially annulate, circinate, loop-shaped, ring-shaped, doughnut-shaped, oval-shaped, or round,
is substantially symmetrical, and
comprises a resilient material, and
wherein
the expandable connector is a continuous loop that is capable of being expanded to allow mounting of the wrist support on the user's wrist,
the continuous loop remains continuous during mounting,
each cushioning element of the plurality of cushioning elements has portions defining a hole through the cushioning element,
the expandable connector is conducted through the hole,
each cushioning element is disposed adjacent to another cushioning element, wherein the ring is substantially symmetrical, and
the substantially spherical cushioning elements are arranged radially about the central axis of the ring.

12. The wrist support of claim 11 wherein the connector comprises a first end and a second end opposite the first end, and wherein the first end and the second end are joined, thereby forming the continuous loop.

13. A wrist support for supporting a wrist of a user comprising:
a. a plurality of substantially spherical cushioning elements, and
b. an expandable connector for connecting the cushioning elements together,
wherein:
the wrist support is substantially annulate, circinate, loop-shaped, ring-shaped, doughnut-shaped, oval-shaped, or round,
the wrist support is substantially symmetrical,
the expandable connector is an elastic cord,
the elastic cord is a continuous loop capable of being expanded to allow mounting of the wrist support on the user's wrist,
the continuous loop remains continuous during mounting,
each cushioning element has portions defining a hole through the cushioning element,
the expandable connector is conducted through the hole,
the substantially spherical cushioning elements are arranged adjacent to one another in a ring,
the substantially spherical cushioning elements are arranged radially about the central axis of the ring, and
the cushioning elements are capable of rotating around the expandable connector.

14. A method for supporting a wrist of a user engaged in an activity that involves repetitive wrist or hand movements comprising:
providing the user with a wrist support, said wrist support comprising:
a. a plurality of cushioning elements, and
b. a connector for connecting the cushioning elements together,
wherein the wrist support is substantially an annulus, and
wherein the cushioning elements:
comprise a resilient material,
are arranged adjacent to one another in the annulus,
are arranged radially about the central axis of the annulus, and
are capable of being disposed on the user's wrist in a position wherein the user experiences minimal or no wrist strain;
and wearing the wrist support on the wrist during repetitive wrist or hand movements.

15. A method for ameliorating or preventing Repetitive Strain Injury (RSI) in a wrist of a user engaged in an activity that involves repetitive wrist or hand movements comprising:
providing the user with the wrist support, said wrist support comprising:
a. a plurality of cushioning elements, and
b. a connector for connecting the cushioning elements together,
wherein the wrist support is substantially an annulus, and
wherein the cushioning elements:
comprise a resilient material,
are arranged adjacent to one another in the annulus,
are arranged radially about the central axis of the annulus, and
are capable of being disposed on the user's wrist in a position wherein the user experiences minimal or no wrist strain; and
wearing the wrist support on the wrist during the repetitive wrist or hand movements,
wherein the wearing of the wrist support aligns the wrist in an alignment that is beneficial for wrist health or safety.
